(19) United States
(12) Patent Application Publication
(10) Pub. No.: US 2026/0002490 A1
(43) Pub. Date: Jan. 1, 2026

(54) Load Controlling Slider Assembly

(71) Applicant: The Boeing Company, Arlington, VA (US)

(72) Inventor: Trevor G. Sleath, Green Valley, AZ (US)

(21) Appl. No.: 18/754,698

(22) Filed: Jun. 26, 2024

(51) Int. Cl. F02K 1/09; F02K 1/18

(52) U.S. Cl. CPC F02K 1/09; F02K 1/18; F05D 2220/323; F05D 2250/41; F05D 2260/15; F05D 2260/31

(57) ABSTRACT

A slider assembly configured to transfer excess load from a first section of a structure to a second section of a structure. The slider assembly includes a bracket and fasteners that are movably connected to the bracket. The fasteners are configured to move through the bracket when a load applied to the first section is below a threshold to maintain a gap between the bracket and the first section to permit the transfer of load from the first section to the second section without loading the slider assembly. The fasteners are further configured to move through the bracket a greater amount when the load applied to the first section is above the threshold to eliminate the gap to transfer at least a portion of the load from the first section to the second section via the slider assembly.

### TECHNOLOGICAL FIELD

The present disclosure relates generally to the field of load transfer assemblies and, more specifically, to load transfer assemblies that bypass a load up to a threshold and to transfer at least a portion of the load when the load exceeds the threshold.

### BACKGROUND

Mechanical structures are designed to withstand a load that is applied to the structure. The design may enable operation of the mechanical structure during a first set of operating conditions, such as the expected conditions that occur during a normal operation. The structures may not be designed to handle an excessive load, such as a high load that occurs during an extreme event.

It is sometimes desirable to upgrade an existing mechanical structure to accommodate higher loads without compromising existing performance. However, the upgrade may not be feasible for one or more reasons. In one example in which the structure includes a metal component and is used in a high-temperature environment, installing a reinforcing member directly onto the metal component can result in thermal expansion mismatches. In another example in which the structure is a component on an aircraft, installing additional strengthening members adds excessive weight that reduces the efficiency of the aircraft. In another example in which the structure is an engine, access to the engine may not be feasible. Access may require removing the engine and/or removing additional components that block access to the engine. These steps of accessing the engine may not be practical, particularly when a large number of structures need to be serviced. One specific context is when each aircraft in a large fleet require reinforcing structures to be added to the aircraft engines.

### SUMMARY

One aspect is directed to a slider assembly configured to transfer excess load from a first section of a structure to a second section of a structure. The slider assembly comprises a bracket configured to be connected to the second section of the structure with the bracket comprising a plurality of openings that are spaced apart. Fasteners extend through the openings and are sized to axially move through the openings with the fasteners configured to connect to the first section of the structure. The fasteners are configured to move through the openings when a load applied to the first section is below a threshold to maintain a gap between the bracket and the first section to enable the transfer of the load from the first section to the second section without loading the slider assembly. The fasteners are configured to move through the openings a greater amount when the load applied to the first section is above the threshold to eliminate the gap to transfer at least a portion of the load from the first section to the second section via the slider assembly.

In another aspect, the bracket comprises a floor configured to be connected to the second section of the structure and a wall that extends from the floor with the openings extending through the wall.

In another aspect, the openings are spaced apart across a width of the wall.

In another aspect, each of the fasteners comprises: a body with an elongated shape that extends through one of the openings with the body comprising a sectional size that is smaller than the opening; a head at a first end of the body with the head comprising a larger sectional size than the opening to prevent the head from passing through the opening; and a distal end configured to engage with the first section.

In another aspect, a first retaining member is positioned on a first side of the openings in the bracket, a second retaining member is positioned on a second side of the openings in the bracket, and each of the first retaining member and the second retaining member comprises openings through which the fasteners extend.

In another aspect, bushings extend around the fasteners with the bushings comprising a cylindrical shape with a first end positioned at the second retaining member and a second end positioned at the first retaining member.

In another aspect, the bushings have a smaller sectional size than the openings in the bracket to enable the bushings to move through the openings during movement between of the first section relative to the second section.

In another aspect, the fasteners are configured to move through the openings when the load applied to the first section is above the threshold to enable the bracket to be contacted by the first section to transfer at least a portion of the load from the first section to the second section via the slider assembly.

In another aspect, the structure comprises a nozzle of a jet engine and the first section is one bay of the nozzle and the second section is another bay of the nozzle.

In another aspect, the fasteners are aligned in a parallel configuration.

One aspect is directed to a slider assembly configured to transfer excess load from a first section of a structure to a second section of a structure. The slider assembly comprises a bracket comprising a floor configured to be connected to the second section of the structure, a wall that extends from the floor, and openings that extend through and are spaced apart across the wall. Fasteners are connected to the bracket with each of the fasteners comprising a body with an elongated shape that extends through one of the openings with the body comprising a sectional size that is smaller than the opening, a head at a first end of the body with the head having a larger sectional size than the opening to prevent the head from passing through the opening, and a distal end configured to engage with the first section. The fasteners are configured to move through the openings to enable the first section forward end to move toward the second section to transfer at least a portion of the load from the first section to the second section via the slider assembly when the load exceeds a threshold.

In another aspect, the fasteners are configured to move through the openings a first amount when the load applied to the first section is below a threshold to maintain a gap between the wall and the first section to enable the transfer of the load from the first section to the second section without loading the slider assembly.

In another aspect, the fasteners are configured to move through the openings a greater second amount when the load applied to the first section is above the threshold to enable the wall to be contacted by the first section to transfer at least a portion of the load from the first section to the second section via the slider assembly.

In another aspect, a first plate is positioned on a first side of the wall, a second plate is positioned on a second side of the wall, and each of the first plate and the second plate comprises openings through which the fasteners extend.

In another aspect, bushings extend around the fasteners and extend through the openings in the wall with the bushings positioned between the first plate and the second plate.

In another aspect, anchors extend through the floor to connect the bracket to the second section.

In another aspect, the fasteners are aligned in a parallel configuration.

One aspect is directed to a method of transferring excess load from a first section of a structure to a second section of a structure. The method comprises: applying a load to the first section and moving fasteners connected to the first section through openings in a bracket that is connected to a second section; maintaining a gap between the bracket and the first section while applying the load and moving the fasteners through the openings in the bracket; increasing the load to the first section and moving the fasteners a greater amount through the openings in the bracket; and eliminating the gap and transferring at least a portion of the load from the first section to the second section via the slider assembly.

In another aspect, the method further comprises contacting the first section against the bracket and transferring at least a portion of the load to the second section via the slider assembly.

In another aspect, the method further comprises contacting a retaining bracket against the bracket and transferring the excess load to the second section with the retaining bracket positioned along the fasteners between bracket and the first section.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is a schematic diagram of a slider assembly mounted across a first section of a structure.

FIG. 2 is an isometric view of an aircraft.

FIG. 3 is an isometric view of slider assemblies mounted to a structure.

FIG. 4 is an isometric view of a slider assembly mounted across a first section of a structure.

FIG. 5 is a schematic section view of a slider assembly with a fore/aft gap formed between a bracket and a first section of a structure.

FIG. 5A is a partial schematic section view of the slider assembly of FIG. 5 with the fore/aft gap eliminated between the bracket and the first section.

FIG. 6 is a flowchart diagram of a method of transferring a load from a first section of a structure to a second section of a structure when the load exceeds a certain threshold.

### DETAILED DESCRIPTION

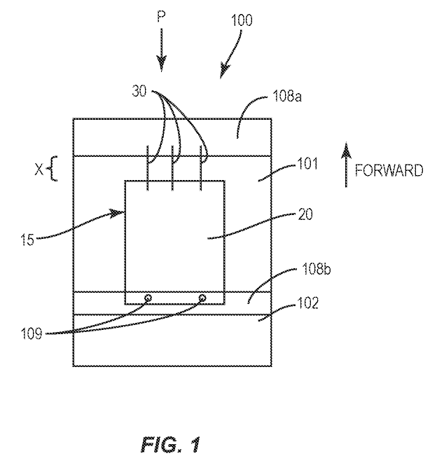

FIG. 1 schematically illustrates a slider assembly 15 that includes a bracket 20 and elongated fasteners 30. The slider assembly 15 is mounted to a structure 100 that includes a first section 101 and a second section 102. The mounting includes the bracket 20 connected to a stiffener 108b such as through one or more anchors 109 and set at a fixed position on the structure 100. The fasteners 30 are movably attached to the bracket 20 and extend outward and are connected to a stiffener 108a. The fasteners 30 have a length to form a gap X between the bracket 20 and the stiffener 108a where the fasteners 30 connect. During normal operation of the structure 100, loads applied to the first section 101 are transferred directly to section 102 without going through the slider assembly 15. The gap X remains substantially constant. In some examples, the gap X can vary due to temperature differences between the first section 101 and the bracket 20. The available movement limits the build-up of thermally induced loads in the assembly 15. The gap X also prevents a mechanical load from being transferred to the second section 102 via the bracket 20. During an event in which a larger load P is applied to the first section via stiffener 108a, the first section 101 may buckle, and the fasteners 30 move relative to the bracket 20 such that the gap X is eliminated. This results in at least a portion of the load on the first section 101 to be transferred to the second section 102 via the bracket 20.

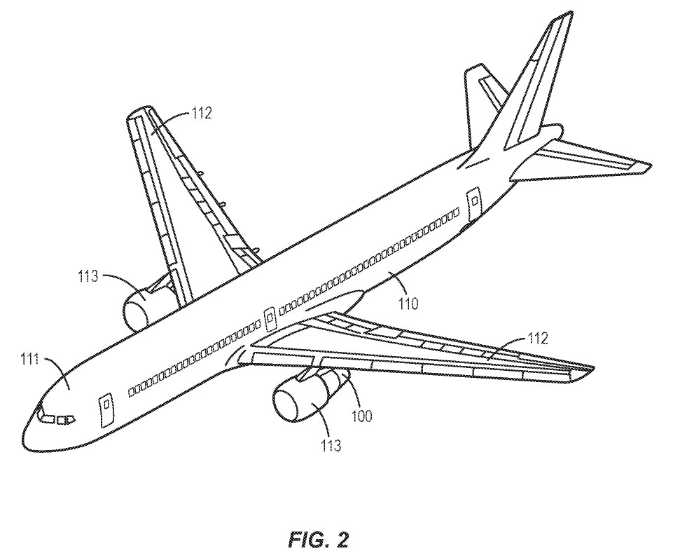

The slider assembly 15 is applicable for use on structures 100 in a variety of contexts. One use is on an aircraft as illustrated in FIG. 2. The aircraft generally includes a fuselage 110 with a flight deck 111 equipped with controls configured to operate the aircraft during flight. A rear section of the fuselage 110 is equipped to accommodate passengers and/or cargo. Wings 112 extend outward from the fuselage 110 and engines 113 are mounted on the wings 112 to propel the aircraft. The engines 113 include nozzles 100 shaped to produce thrust from the exhaust gases that are emitted from an engine core.

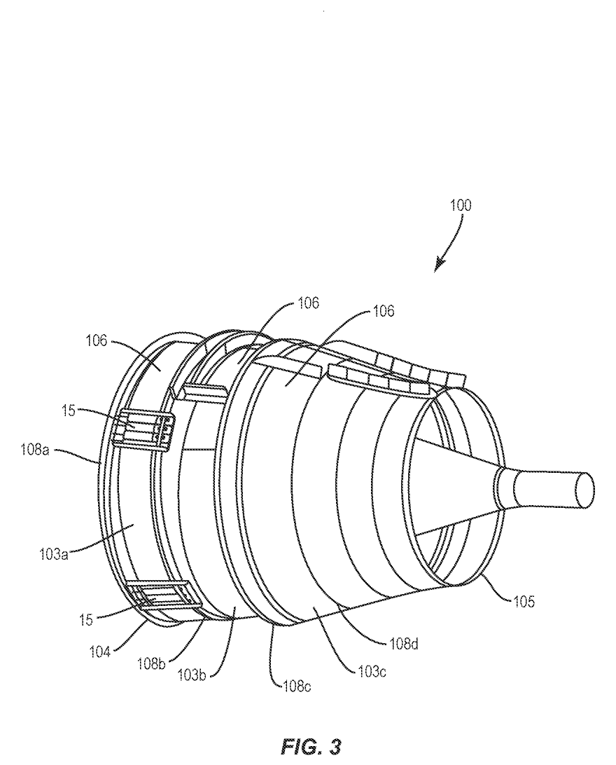

FIG. 3 illustrates a nozzle 100 that is equipped with slider assemblies 15. The nozzle 100 has a substantially tubular shape that includes cylindrical bays 103 that extends along the length between a forward end 104 and an aft end 105. The bays 103 include a skin 106 and support stiffeners 108. The number and positioning of the slider assemblies 15 on the nozzle 100 can vary depending upon the context. In one example, the slider assemblies 15 are mounted across the first bay 103a. This positioning enables support for the forward section of the nozzle 100 in proximity to the forward end 104. One specific example provides for supporting the nozzle 100 during an engine event, such as a fan blade out (FBO).

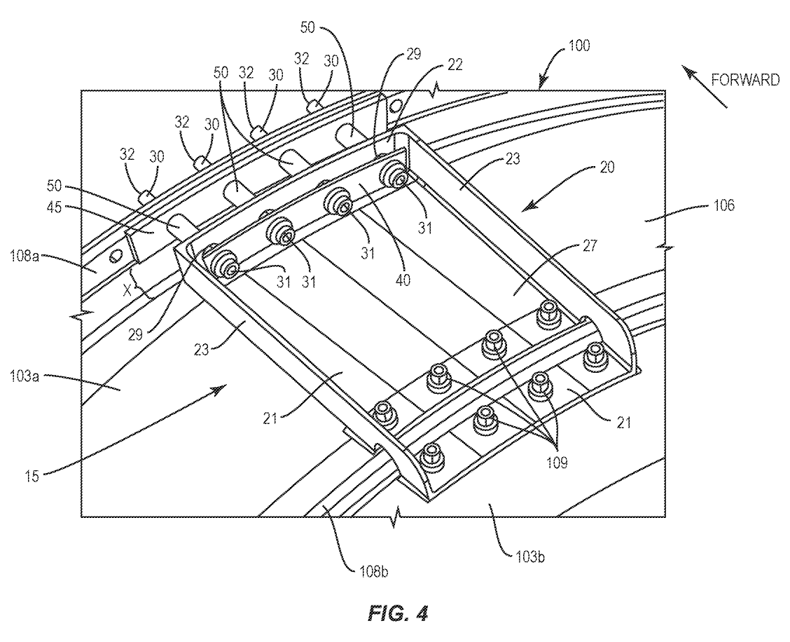

FIG. 4 illustrates the slider assembly 15 mounted to the nozzle 100. The slider assembly 15 includes the bracket 20 and the fasteners 30. The bracket 20 extends across the first bay 103a and is mounted to the stiffener 108b on one side. The fasteners 30 extend outward from the bracket 20 and connect to a stiffener 108a on the other side of first bay 103a. The fasteners 30 may be further connected to other structures such as the engine core or engine case (not illustrated).

The slider assembly 15 enables the first bay 103a to behave independently of the slider assembly 15 during normal operating conditions. This occurs through the relative movement between the fasteners 30 and the bracket 20. The gap X formed at the fasteners 30 expands and contracts during normal use including when various loads are applied to the nozzle 100 such as caused by the heating and cooling of the nozzle 100. In the event an excessive compressive load is applied in a fore/aft direction, the first bay 103a buckles. This causes the bracket 20 to move along the fasteners 30 until bottoming out by contacting against the stiffener 108a (i.e., the gap X is zero). When bottoming out, the excess load applied to the first bay 103a is transferred directly to the second bay 103b via the bracket 20. In some examples, the bottoming out occurs when the bracket 20 directly contacts the forward stiffener 108a. In other examples, one or more intermediate members are positioned between the bracket 20 and the forward stiffener 108a and prevent direct contact but still enable the transfer of the load.

As illustrated in FIG. 4, the bracket 20 includes a floor 21 that is in close proximity to the skin 106 of the first bay 103a. A forward wall 22 and side walls 23 extend around a portion of the perimeter edge of the floor 21. The forward wall 22 includes openings 29 spaced apart across the width. The bracket 20 is positioned with the forward wall 22 positioned in proximity to the stiffener 108a. The gap X is formed between the forward wall 22 and the stiffener 108a.

Anchors 109 extends through the floor 21 and are secured to the stiffener 108b.

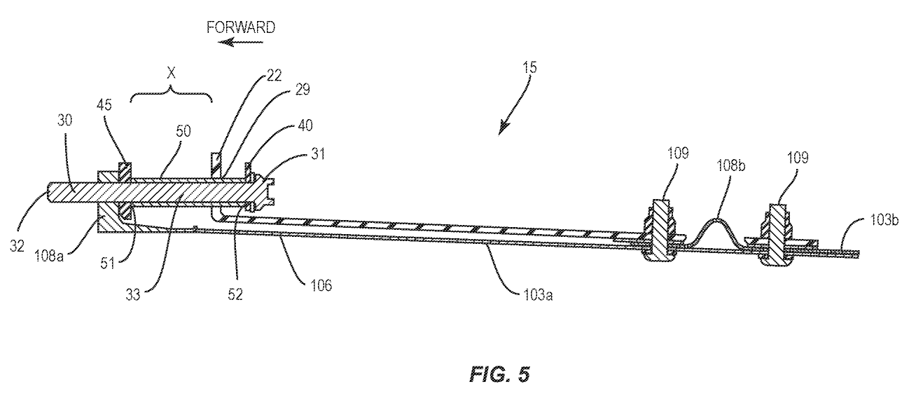

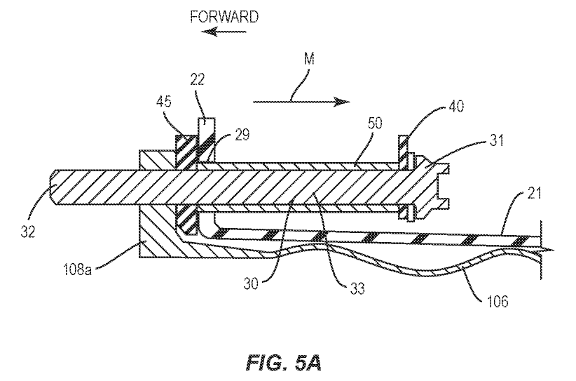

The fasteners 30 extend through the openings 29 in the forward wall 22. As illustrated in FIGS. 4 and 5, the fasteners 30 include an elongated body 33 with a head 31 positioned on a rear side of the forward wall 22 and a distal end 32 on a forward side of stiffener 108a. The ends 32 are configured to extend into and connect with one or more other structures, such as the engine core or engine case. In some examples, the ends 32 are threaded to enable the connection. The fasteners 30 have a length to extend across the gap X formed between the forward wall 22 and the stiffener 108a. In some examples, the fasteners 30 are in a parallel configuration with a longitudinal centerline of each fastener 30 being parallel.

A retaining bracket 40 is positioned on a side of the forward wall 22 opposite from the stiffener 108a. The retaining bracket 40 includes openings through which the fasteners 30 extend. The openings are smaller than the heads 31 of the fasteners 30 to prevent the heads 31 from passing. A second retaining bracket 45 is positioned at the stiffener 108a. The second bracket 45 includes openings through which the fasteners 30 extend.

As illustrated in FIGS. 4 and 5, bushings 50 extends around the fasteners 30. The bushings 50 include an elongated length with a first end 51 that abuts against the retaining bracket 45 and a second end 52 that abuts against the retaining bracket 40. The bushings 50 have a length to extend through the openings in the forward wall 22 and across the gap X. The bushings 50 space apart the retaining brackets 40, 45 for the various load cases.

During normal use, the slider assembly 15 enables the first bay 103a to absorb the applied loads. For example, the temperature differentials that are applied during normal operation of the engine 113. The slider assembly 15 enables relative movement between the first bay 103a and itself as the size of the gap X changes during the movement. This movement limits the build-up of thermally induced loads between the first bay 103a and the bracket 20. The gap X also prevents mechanical load from being transferred to the second bay 103 via the bracket 20. When the applied loads on the first bay 103a become much larger and cause the first bay 103a to start to fail, the slider assembly 15 transfers the excess load from the first bay 103a to the second bay 103b. The transfer occurs due to the partial collapse of the first bay 103 causing the gap X to be reduced to zero as the retaining bracket 45/stiffener 108a contacts against the forward wall 22. In one example, this occurs when the first bay 103a buckles due to the force. This contact causes the bracket 20 to transfer a substantial part of the load to the second bay 103b, while the remainder of the load is carried by direct transfer from the (buckled) first bay 103a to the second bay 103b. Thus, the slider assembly 15 enables loads to transfer from a primary load path to a second load path, but only in the event that the primary load path starts to fail.

FIG. 5A illustrates a section of the slider assembly 15 when the slider assembly is bottomed out to transfer the load. The load causes the rib 108a to move in the direction of arrow M towards the wall 22. The fasteners 30 have slid through the openings 29 with a majority of the body 33 now positioned on the opposing side (e.g., rear ward side) of the wall 22. This movement causes the slider assembly 15 to bottom out by the gap being eliminated and the rib 108a contacting against the wall 22 either directly or indirectly. This contact causes the bracket 20 to transfer a substantial part of the load to the second bay 103b, while the remainder of the load is carried via direct transfer from the (buckled) first bay 103a to the second bay 103b.

In structures 100 with multiple slider assemblies 15, the relative movement and bottoming out between the different slider assemblies 15 can vary. In some examples, each of the slider assemblies 15 bottom out. In other examples, one or more of the slider assemblies bottom out while one or more other slider assemblies 15 remain with a position gap X.

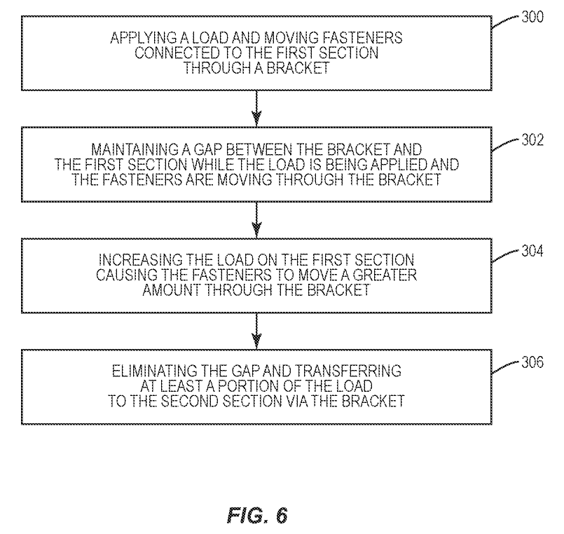

FIG. 6 illustrates a method of transferring an excess load from a first section 101 of a structure 100 to a second section 102. The method includes applying a significant load to the first section 101 and moving fasteners 30 connected to the first section through openings 29 in a bracket 20 that is connected to a second section 102 (block 300). A gap is maintained between the bracket 20 and the first section 101 while the load is being applied and the fasteners 30 are moving through the openings 29 in the bracket 20 (block 302). The load on the first section 101 is increased causing the fasteners 30 to move a greater amount through the openings 29 in the bracket 20 (block 304). This additional movement eliminates the gap and transfers at least a portion of the load from the first section 101 to the second section 102 via the bracket 20 (block 306).

In some examples, a portion of the load is transferred from the first section 101 to the second section 102 via the bracket 20 when the gap is eliminated. In other examples, an entirety of the load is transferred.

The slider assembly 15 is applicable for a variety of uses. One example is retrofitting a nozzle 100 of an engine 113 with four slider assemblies 15. The slider assemblies 15 are mounted over the first bay 103a (i.e., most forward bay). The first bay 103a includes a cylindrical skin 106 bounded by hoop stiffeners 108 at each end. The slider assemblies 15 are mounted with the brackets 20 bolted securely to the aft stiffener 108b and secured with four fasteners 30 to the forward stiffener 108a. During normal operations, the slider joints formed by the bracket 20 and fastener 30 ensure that no axial load (whether due to thermal expansion, sonic, pressure, etc.) is transmitted through the reinforcing bracket 20. In some examples, the openings 29 are carefully sized to also eliminate load transfer in the hoop direction. This arrangement allows the first bay 103a to behave independently of the slider assemblies 15 during normal operations.

If an event were to occur, additional loads are placed on the first bay 103a. One example of an event is a failure of the fan of the turbine engine. This failure can cause inertial imbalance to the engine 113. These loads get transmitted to the nozzle 100 as enforced displacements in both hoop-wise and axial directions. The additional loads can cause the first bay 103a to partially collapse. In this situation, the gap X reduces to zero as the retaining bracket 45/stiffener 108a contact against the bracket 20. This contact causes the excess load to transfer to the second bay 103b via the brackets 20.

The amount of load that is carried by the first bay 103a is a function of the length of the fasteners 30. Longer lengths of the fasteners 30 provide for the first bay 103a to carry a larger load before the gap X closes. By adjusting the length of the fasteners 30 and the size of the gap X, it is possible to control the distribution of enforced displacements between the first and second bays 103a, 103b, and thereby control the distribution of post-buckle damage to each.

An advantage of the slider assembly 15 is the ability to retrofit an existing nozzle 100. The slider assembly 15 can be mounted to a nozzle 100 without compromising the existing performance. The slider assembly 15 can be mounted to an engine 113 that is mounted on the wing 112 of an aircraft. It is not necessary to remove the engine 113 from the wing 112. Further, the slider assembly 15 is relatively light weight and does not cause a noticeable affect on the efficiency of the aircraft.

In some examples, an additional advantage of the sider joint as illustrated is that no shimming is needed in the fore/aft direction for bracket installation. Fore/aft tolerancing inherent in the nozzle can be accounted for by increasing the slider range. For example, this can be used to accommodate the positional tolerance of the aft stiffener 108b.

In some examples, the nozzles 100 are equipped with one or more slider assemblies. In some examples, the nozzles 100 of each of the engines 113 are equipped with one or more slider assemblies 15. In other examples, a limited number of the engines 113 are equipped with one or more slider assemblies 15.

The number of fasteners 30 in the slider assembly 15 can vary. Examples include a single fastener 30 up to many multiple fasteners 30.

The slider assembly 15 can be used in a variety of different contexts. Use on an aircraft is one example. Other examples include use on other vehicles, industrial equipment, safety equipment, and various other contexts wherein structural reinforcements are needed for an extreme condition but are not otherwise desirable.

By the term “substantially” with reference to amounts or measurement values, it is meant that the recited characteristic, parameter, or value need not be achieved exactly. Rather, deviations or variations, including, for example, tolerances, measurement error, measurement accuracy limitations, and other factors known to those skilled in the art, may occur in amounts that do not preclude the effect that the characteristic was intended to provide.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A slider assembly configured to transfer excess load from a first section of a structure to a second section of a structure, the slider assembly comprising:
a bracket configured to be connected to the second section of the structure, the bracket comprising a plurality of openings that are spaced apart;
fasteners extending through the openings and are sized to axially move through the openings, the fasteners being configured to connect to the first section of the structure;
wherein the fasteners are configured to move through the openings when a load applied to the first section is below a threshold to maintain a gap between the bracket and the first section to enable the transfer of the load from the first section to the second section without loading the slider assembly; and
wherein the fasteners are configured to move through the openings a greater amount when the load applied to the first section is above the threshold to eliminate the gap to transfer at least a portion of the load from the first section to the second section via the slider assembly.

2. The slider assembly of claim 1, wherein the bracket comprises a floor configured to be connected to the second section of the structure and a wall that extends from the floor with the openings extending through the wall.

3. The slider assembly of claim 2, wherein the openings are spaced apart across a width of the wall.

4. The slider assembly of claim 1, wherein each of the fasteners comprising:
a body with an elongated shape that extends through one of the openings, the body comprising a sectional size that is smaller than the opening;
a head at a first end of the body, the head comprising a larger sectional size than the opening to prevent the head from passing through the opening; and
a distal end configured to engage with the first section.

5. The slider assembly of claim 1, further comprising:
a first retaining member positioned on a first side of the openings in the bracket;
a second retaining member positioned on a second side of the openings in the bracket; and
wherein each of the first retaining member and the second retaining member comprises openings through which the fasteners extend.

6. The slider assembly of claim 5, further comprising bushings that extend around the fasteners, the bushings comprising a cylindrical shape with a first end positioned at the second retaining member and a second end positioned at the first retaining member.

7. The slider assembly of claim 6, wherein the bushings have a smaller sectional size than the openings in the bracket to enable the bushings to move through the openings during movement between of the first section relative to the second section.

8. The slider assembly of claim 1, wherein the fasteners are configured to move through the openings when the load applied to the first section is above the threshold to enable the bracket to be contacted by the first section to transfer at least a portion of the load from the first section to the second section via the slider assembly.

9. The slider assembly of claim 1, wherein the structure comprises a nozzle of a jet engine and the first section is one bay of the nozzle and the second section is another bay of the nozzle.

10. The slider assembly of claim 1, wherein the fasteners are aligned in a parallel configuration.

11. A slider assembly configured to transfer excess load from a first section of a structure to a second section of a structure, the slider assembly comprising:
a bracket comprising:
a floor configured to be connected to the second section of the structure;
a wall that extends from the floor;
openings that extend through and are spaced apart across the wall;
fasteners that are connected to the bracket, each of the fasteners comprising:
a body with an elongated shape that extends through one of the openings, the body comprising a sectional size that is smaller than the opening;
a head at a first end of the body, the head having a larger sectional size than the opening to prevent the head from passing through the opening;
a distal end configured to engage with the first section;
wherein the fasteners are configured to move through the openings to enable the first section forward end to move toward the second section to transfer at least a portion of the load from the first section to the second section via the slider assembly when the load exceeds a threshold.

12. The slider assembly of claim 11, wherein the fasteners are configured to move through the openings a first amount when the load applied to the first section is below a threshold to maintain a gap between the wall and the first section to enable the transfer of the load from the first section to the second section without loading the slider assembly.

13. The slider assembly of claim 12, wherein the fasteners are configured to move through the openings a greater second amount when the load applied to the first section is above the threshold to enable the wall to be contacted by the first section to transfer at least a portion of the load from the first section to the second section via the slider assembly.

14. The slider assembly of claim 12, further comprising:
a first plate positioned on a first side of the wall;
a second plate positioned on a second side of the wall;
each of the first plate and the second plate comprising openings through which the fasteners extend.

15. The slider assembly of claim 14, further comprising bushings that extend around the fasteners and that extend through the openings in the wall, the bushings positioned between the first plate and the second plate.

16. The slider assembly of claim 14, further comprising anchors that extend through the floor to connect the bracket to the second section.

17. The slider assembly of claim 12, wherein the fasteners are aligned in a parallel configuration.

18. A method of transferring excess load from a first section of a structure to a second section of a structure, the method comprising:
applying a load to the first section and moving fasteners connected to the first section through openings in a bracket that is connected to a second section;
maintaining a gap between the bracket and the first section while applying the load and moving the fasteners through the openings in the bracket;
increasing the load to the first section and moving the fasteners a greater amount through the openings in the bracket; and
eliminating the gap and transferring at least a portion of the load from the first section to the second section via the slider assembly.

19. The method of claim 18, further comprising contacting the first section against the bracket and transferring at least a portion of the load to the second section via the slider assembly.

20. The method of claim 18, further comprising contacting a retaining bracket against the bracket and transferring the excess load to the second section with the retaining bracket positioned along the fasteners between bracket and the first section.
